(19) United States
(12) Patent Application Publication
(10) Pub. No.: US 2004/0256244 A1
(43) Pub. Date: Dec. 23, 2004

(54) Selective electrochemical etching method for two-dimensional dopant profiling

(75) Inventor: Chel-jong Choi, Gyeonggi-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Gyeonggi-do (KR)

(21) Appl. No.: 10/828,183

(22) Filed: Apr. 21, 2004

(30) Foreign Application Priority Data
Jun. 18, 2003 (KR) 10-2003-0039352

(51) Int. Cl. C25F 3/00; B23H 3/00; C25F 7/00

(52) U.S. Cl. 205/640

(57) ABSTRACT

Provided is a selective electrochemical etching method in which, when a facing electrode faces a substrate having at least one doping region on an upper surface and a contact layer on a bottom surface and a bias voltage is applied to the substrate, the doping region is selectively etched depending on a doping concentration of the doping region within a bath which contains an etchant. The bias voltage is applied to the bottom surface of the substrate, which is opposite to the upper surface on which the doping region is formed, so that a hole current is supplied to the substrate via the bottom surface of the substrate. Accordingly, a contact layer is formed on the bottom surface of a specimen so as to deliver a hole current to the substrate, whereby a more precise, more reproducible doping profile can be obtained than in a conventional electrochemical etching method.

### BACKGROUND OF THE INVENTION

This application claims the benefit of Korean Patent Application No. 2003-39352, filed on Jun. 18, 2003, in the Korean Intellectual Property Office, the disclosure of which is incorporated herein in its entirety by reference.

1. Field of the Invention

The present invention relates to an electrochemical etching method, and more particularly, to a selective electrochemical etching method for two-dimensional dopant profiling in pn junction.

2. Description of the Related Art

Since the mid 1980's, a remarkable development of a silicon (Si) semiconductor manufacturing process has contributed to reducing the size of a semiconductor device to a submicron or smaller size. One of techniques enabling the manufacture of such a minute semiconductor device is ion implantation in which a dopant with accurately adjusted energy and dose is fast implanted into a substrate.

To realize a highly-integrated, high-performance Si semiconductor device and accurately control the operational characteristics of the device, accurate information about the profile of an injected dopant must be secured.

To do this, a secondary ion mass spectroscopy (SIMS), a spreading resistance profiling (SRP), or the like is widely used. In the SIMS or SRP, a one-dimensional dopant distribution on an area of the substrate with a size of several hundreds of microns (μm) in the direction perpendicular to the substrate can be profiled. However, profiling a dopant on a two-dimensional area of a predetermined or submicron size is difficult. In other words, for obtaining information about a two-dimensional profiling including vertical and lateral profilings of a dopant existing in a channel region below a gate, SIMS and SRP techniques have a limitation due to a difficulty in specimen preparation and a low spatial resolution.

A selective chemical etching is proposed to overcome the aforementioned limitation of the SIMS or SRP. A dopant existing within an n+/p junction, for example, a 5-Group element, such as arsenic (As), can be easily profiled using the selective chemical etching. However, a dopant existing within a p+/n junction, for example, a 3-Group element, such as boron, cannot be easily profiled even though the selective chemical etching is used. This is because the mechanism of the selective chemical etching is closely related to the supply of a hole current. To solve this problem, that is, to profile a dopant existing within a p+/n junction, a method of injecting a hole current into an Si substrate by projecting ultraviolet (UV) rays to the Si substrate upon selective chemical etching is proposed by J. Liu, M. L. A. Dass, and R. Gronsky in Journal of Vacuum Science & Technology, B12, (1994) pp. 353. However, this method has two disadvantages in that an etching rate sensitively varies with a change in the distance between a UV lamp for UV illumination and a specimen and that an etching sensitivity is greatly lower than the profile of arsenic (As) existing within an n+/p junction. Furthermore, the hole current injection method has a more serious disadvantage in that a dopant profile varies according to the thickness of a specimen. This disadvantage of the hole current injection method is discussed by C. Spinella in Material Science in Semiconductor Processing, 1, (1998) pp. 55.

C. Spinella has recently proposed a method of two-dimensionally profiling a dopant existing within a p+/n junction using a selective electrochemical etching technique, in Materials Science in Semiconductor Processing, 1, (1998) pp. 55.

In the selective electrochemical etching technique proposed by C.Spinella, as shown in FIG. 1, a specimen is etched within an electrochemical etching bath which contains an etching solution. As shown in FIG. 1, dummy Si is formed on the upper surface of a specimen 100, which is a target of observation, and an Au contact layer 13 and an Ag paint 14 are formed on a second surface opposite to a first surface (i.e., a surface where selective etching occurs) of the specimen. An Au electrode 19 is located a predetermined distance from the first surface of the specimen such as to face the first surface. Current is supplied through an Ag paint 14 connected to a power supplier 18, and a hole current is supplied via the Au electrode 19 connected to the power supplier 18.

To effectively use the electrochemical etching technique, the first surface of the specimen to be observed must be polished, and thereafter Au must be deposited on the second surface. However, during Au deposition on the second surface of the specimen or handing of the specimen, the polished first surface may be easily damaged.

FIG. 2 is an SEM picture of a specimen etched by the above-described electrochemical etching technique, which illustrates a two-dimensional boron profile on a first surface of the specimen. As illustrated in FIG. 2, boron is irregularly distributed on the specimen, resulting in junctions with inconsistent depths. What is worse, as indicated by an arrow, p+ regions, on which boron is distributed, below a gate are connected to each other due to over etching. In other words, it is not easy to obtain a reliable dopant profile using such a conventional selective electrochemical etching technique. It can be considered that one reason why the conventional selective electrochemical etching technique cannot obtain a reliable dopant profile is because an Au contact layer is peeled off from an Si substrate specimen due to a poor adhesion between them, that is, between Au and Si. This reason is described by H. Nagata, T. Shinriki, K. Shima, M. Tamai, and E. M. Haga in Journal of Vacuum Science & Technology, A17, pp. 1018, 1999.

Another reason is due to an inhomogeneous flux of a hole current to the specimen. When a bias is applied to a second surface of the specimen on which a contact layer is formed, a hole current must be uniformly supplied on the entire p+/n region to be analyzed. However, in practice, the hole current flows inhomogeneously into the p+/n region due to a partial thickness difference of the cross-section of a specimen, which is caused during preparation of the specimen, a geometrical distortion of the surface of the specimen, and the like. In other words, the profile of a doped region obtained by etching does not precisely represent an actual doped region and is irreproducible as shown in FIG. 2, because a hole current is not homogeneously supplied to the entire doped region to be observed.

### SUMMARY OF THE INVENTION

The present invention provides a selective electrochemical etching method by which a precise and reproducible two-dimensional profile in p+/n junction can be obtained.

According to an aspect of the present invention, there is provided a selective electrochemical etching method in which, when a facing electrode faces a substrate having at least one doping region on an upper surface and a contact layer on a bottom surface and a bias voltage is applied to the substrate, the doping region is selectively etched depending on a doping concentration of the doping region within a bath which contains an etchant. The bias voltage is applied to the bottom surface of the specimen, which is opposite to the upper surface on which the doping region is formed, so that a hole current is supplied to the substrate via the bottom surface of the substrate.

According to an embodiment of the present invention, the substrate is of an n type, and the contact layer is formed of a material selected from Al, Ti, W, Ta, and V.

According to another embodiment of the present invention, the substrate is of a p type, and the contact layer is formed of a material selected from Au, Ag, Pd, Pt, and Ni.

The contact layer may be formed of aluminum, and an Ag wire may be connected to the contact layer to electrically bias the contact layer.

The bias voltage may be in the range of 0.01 to 100 V, and a thickness of the contact layer may be in the range between 1 nm and 100 μm.

The facing electrode and a wire connected to the facing electrode may be formed of one of Au, Pt, Os, Pd, Ir, Rh, Ru, Co, Ni, Mo, Ti, Fe, W, Ta, V, Be, and Cu.

The etchant may include a hydrofluoric acid (HF).

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional selective electrochemical etching method;

FIG. 2 is an SEM picture of a specimen etched by the conventional electrochemical etching method;

FIGS. 3A through 3F illustrate a specimen fabricating process included in an electrochemical etching method according to an embodiment of the present invention;

FIG. 4 illustrates a selective electrochemical etching method according to an embodiment of the present invention; and

FIG. 5 is an SEM picture of a specimen etched by the electrochemical etching method according to the present invention.

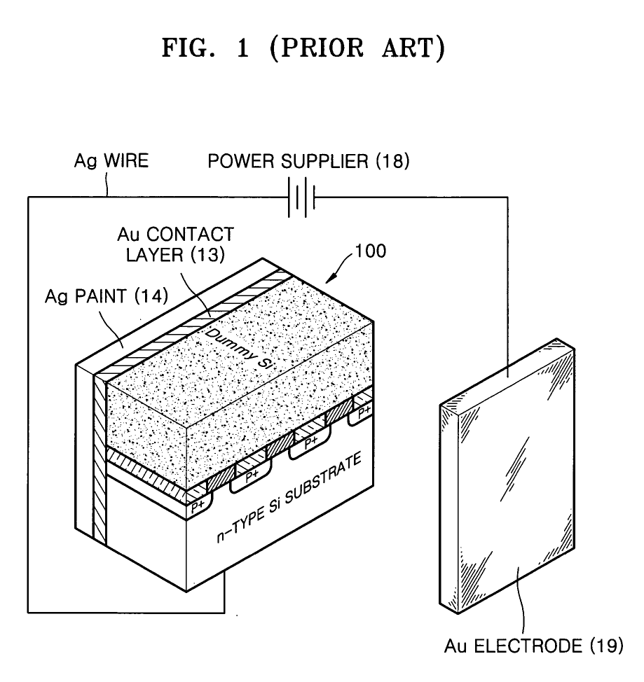

### DETAILED DESCRIPTION OF THE INVENTION

The manufacture of a specimen of a substrate will now be described in detail. Only a specimen, which is separated from a substrate, instead of the entire substrate is shown in the drawings to facilitate understanding of the invention.

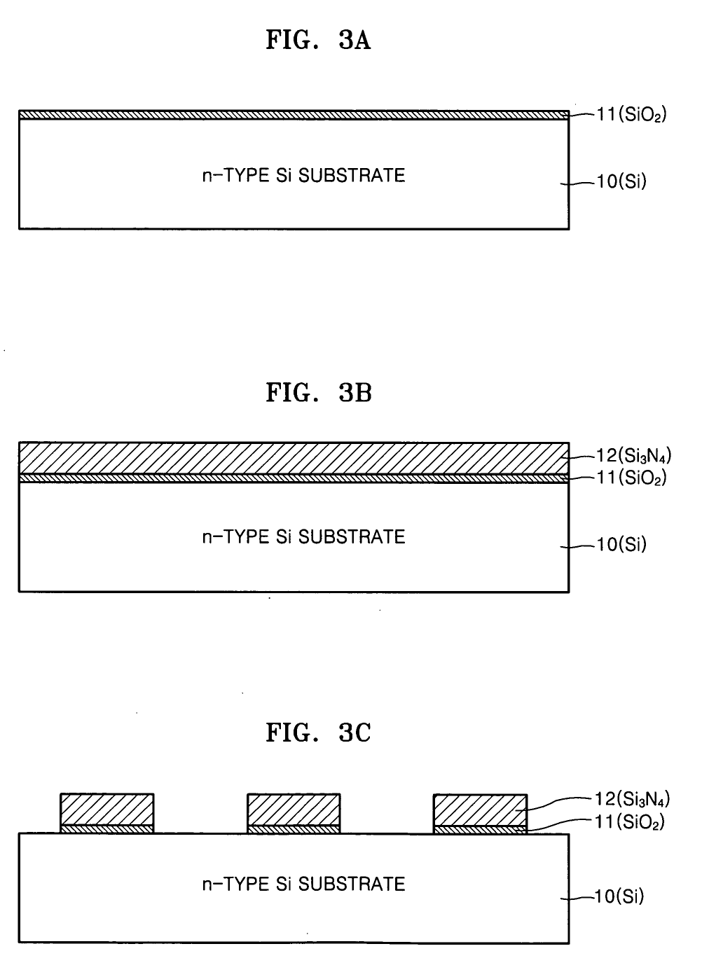

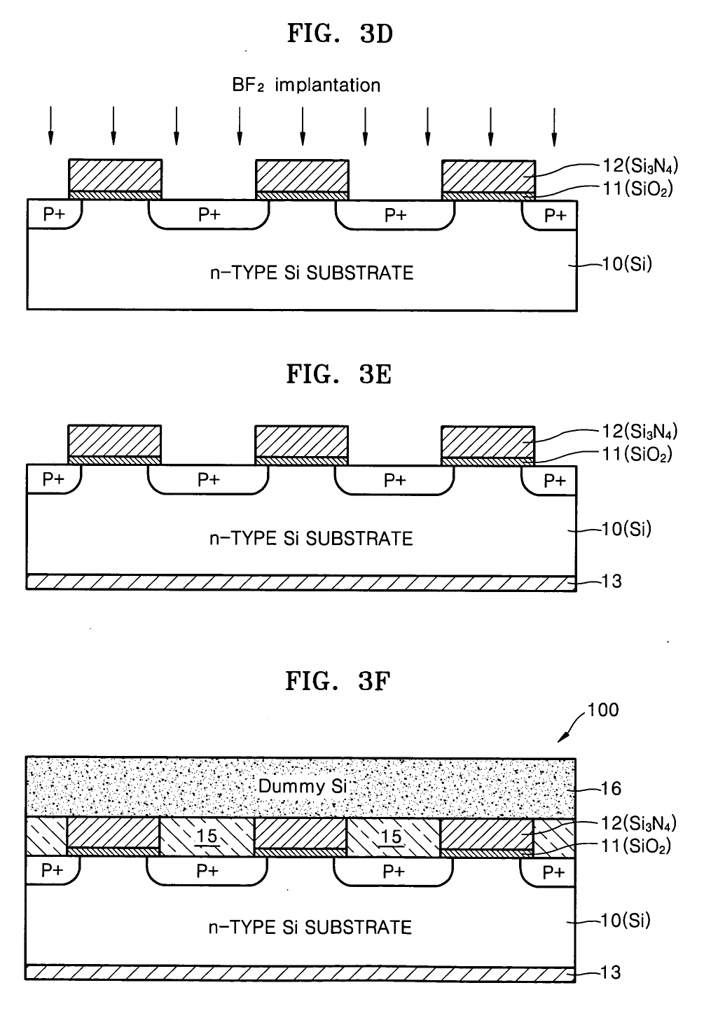

As shown in FIG. 3A, a silicon oxide (SiO₂) film 11, having a length of about 10 nm, is formed on an n-type Si substrate 10 by thermally oxidizing the substrate 10.

As shown in FIG. 3B, a silicon nitride (Si₃N₄) film 12 is deposited on the SiO₂ film 11 to have a predetermined thickness, for example, 160 nm.

As shown in FIG. 3C, the Si₃N₄ film 12 and the SiO₂ film 11 are patterned by photolithography and etching. The pattern of the Si₃N₄ film 12 and the SiO₂ film 11 has a shape corresponding to a gate in an actual device.

As shown in FIG. 3D, an exposed surface of the Si substrate 10 is doped with impurities using an ion implantation apparatus or the like. Here, the impurities is BF₂, for example, and the implantation is performed at an energy of 75 keV and at a concentration of 1×10¹⁵/cm². after the implantation, annealing is performed at 950° C. during about 30 minutes in nitrogen ambient.

As shown in FIG. 3E, a native oxide film (not shown) formed on the bottom surface of the substrate 10 is removed, and thereafter a metal contact layer 13 is formed on the bottom surface of the substrate 10. Preferably, but not necessarily, the metal contact layer 13 is formed of aluminium (Al), which is adhesive to an n-type Si substrate and can be in a good ohmic contact with the n-type Si substrate. The Al contact layer 13 is formed to a thickness of about 500 nm by sputtering.

As shown in FIG. 3F, the substrate 10 is cut to a size that can be easily observed through an electron microscope, thereby obtaining a separate element. Thereafter, dummy Si 16 adheres to the separate element using an adhesive, for example, epoxy 15, thereby obtaining a specimen 100 of a sandwich structure. Then, a to-be-observed surface of the specimen 100 is grinded and polished.

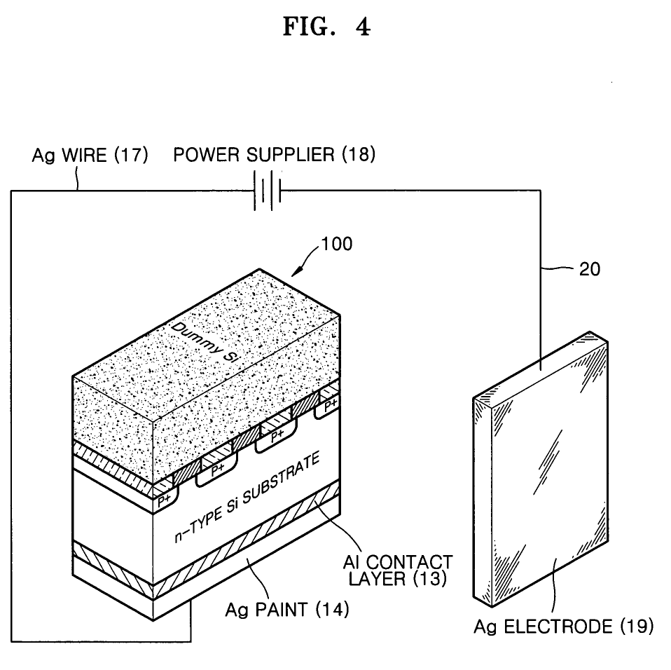

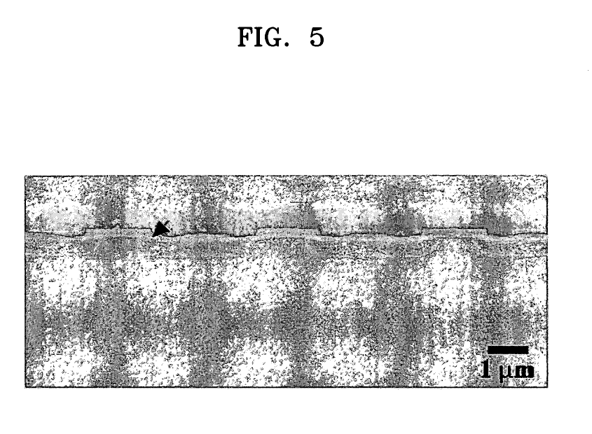

Electrochemical etching of the specimen 100 will now be described in detail. As shown in FIG. 4, first, an Ag wire 17 is fixed to the Al contact layer 13 on the bottom surface of the specimen 100 using an Ag paint 14. Then, the entire surface excluding a first surface of the specimen 100 to be observed is shielded with a corrosion-resistant crystal wax strong against an etchant. Next, the resultant specimen 100 is put into a bath which contains an etchant composed of a hydrofluoric acid, a nitric acid, and an acetic acid at a ratio of 1:100:10, and the first surface of the specimen 100 is selectively and electrochemically etched within the bath. At this time, an Ag electrode 19 is placed such as to face the first surface of the specimen 100, and an Ag wire 20 is connected to the Ag electrode 19. A power supplier 18 is connected to both the Ag wires 17 and 20 and applies a DC bias voltage of about 0.8 V to them. The Al contact layer 13 of the specimen 100 is electrically positive, and the Ag electrode 19 is electrically negative. Hence, a hole current is supplied to the doped area in the upper part of the specimen 100 via the Al contact layer 13, which is formed on the bottom of the specimen 100.

The etching is performed for about 5 seconds, and then the specimen 100 is washed with deionised water to remove an etchant residing on the specimen 100.

The components of the etchant, the mixture ratio of the components, the etching time, and the level of the bias voltage may be appropriately adjusted.

FIG. 5 shows an SEM image of a specimen etched by the electrochemical etching method according to the present invention.

The images clearly demonstrate the presence of thickness fringes that are formed as a result of doping-dependent etching in the doped regions.

are approximately parallel to the Si substrate surface in the middle region of the well, bend upward under the gate oxide, and terminate at the gate oxide/Si substrate interface.

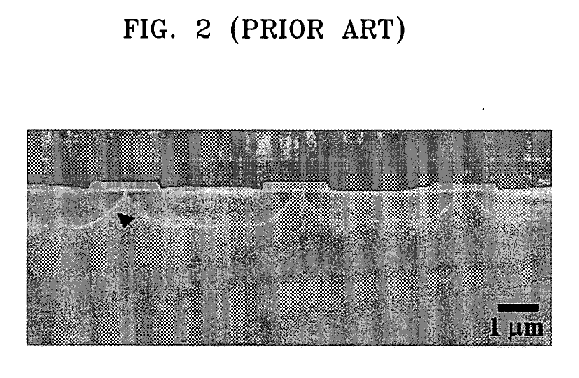

In FIG. 5, it is obviously shown that boron is two-dimensionally distributed in well as the shape of a U-curved iso-concentration line by selective electrochemical etching that depends on the doping concentration. The iso-concentration line of boron is approximately parallel to Si substrate surface in the middle region of the well, but is bent upward at an area below a gate (which corresponds to a silicon nitride film included in a specimen). As a result, the iso-concentration line of boron terminates at an interface between the gate oxide and an Si substrate. In contrast with the result of conventional etching of FIG. 2, all boron profiles shown in FIG. 5 have identical patterns and shapes, implying that an impurity-doped region can be uniformly etched by selective electrochemical etching according to the present invention. Although a reverse bias was applied to the n-type Si substrate from the bottom to the top thereof in order to supply a hole current to the n-type Si substrate from the bottom surface of the specimen 100, the current-voltage (I-V) measurement by a parameter analyzer, HP 4155, shows that a hole current of several μA was supplied to junctions of a present sample. The measured depth of a junction (a distance from the top surface of the Si substrate to the iso-concentration line) at the center of each of the wells in FIG. 5 was 396±5 nm. The junction depth obtained by a SUPREM-IV simulator, which is widely used in an Si device processing simulation, was 390.1 nm, which is similar to the measured depth of 396±5 nm. Also, the corresponding lateral length of iso-concentration line at the gate oxide/Si interface was located at 297.5 nm from the edge of the gate.

The lateral length can serve as a very important parameter that can affect the operational characteristics and performance of a submicron-size MOS device.

Although an n-type substrate and an Al contact layer are used in the above-described embodiment of the invention, the substrate may be of a p type, and the contact layer may be formed of Au.

For example, if the substrate is of an n type, the contact layer may be formed of one of Al, Ti, W, Ta, and V.

If the substrate is of a p type, the contact layer may be formed of one of Au, Ag, Pd, Pt, and Ni.

However, when the substrate is of an n type, the contact layer is preferably, but not necessarily, formed of Au. In this case, a wire connected to the Au contact layer is preferably, but not necessarily, formed of Ag.

Also, although a 0.8 V bias voltage is applied to the specimen 100 and the Ag electrode 19 in the above-described embodiment of the present invention, the bias voltage may be any of 0.01 to 100V.

Furthermore, although the Al contact layer has a thickness of 500 nm in the above-described embodiment of the present invention, it may have a thickness of one of 100 nm to 100 μm.

Also, although an electrode to which current is supplied and a wire connected to the electrode are formed of Ag in the above-described embodiment of the present invention, they may be formed of one of Au, Pt, Os, Pd, Ir, Rh, Ru, Co, Ni, Mo, Ti, Fe, W, Ta, V, Be, and Cu.

In a selective electrochemical etching method according to the present invention, an Al contact layer is formed on the bottom surface of a specimen so as to deliver a hole current to the specimen. Thus, the present method leads to obtain a more realistic, more reproducible doping profile than a conventional electrochemical etching method. A contact layer for an n-type Si substrate is preferably, but not necessarily, formed of Al, which is in a good ohmic contact with the n-type Si substrate. On the other hand, an Au contact layer is not suitable for the n-type Si substrate because it forms a Schottky junction with the n-type Si substrate. As described above, the contact layer may be formed of any of the aforementioned materials because they can be an ohmic contact with Si. Since such an Al contact layer is not easily peeled off from the Si substrate due to a strong adhesion to Si, a hole current can be homogenously distributed in the entire doping region. Thus, a reliable and reproducible two-dimensional dopant profile can be obtained.

What is claimed is:

1. A selective electrochemical etching method in which, when a facing electrode faces a substrate having at least one doping region on an upper surface and a contact layer on a bottom surface and a bias voltage is applied to the substrate, the doping region is selectively etched depending on a doping concentration of the doping region within a bath which contains an etchant, wherein the bias voltage is applied to the bottom surface of the substrate, which is opposite to the upper surface on which the doping region is formed, so that a hole current is supplied to the substrate via the bottom surface of the substrate.

2. The selective electrochemical etching method of claim 1, wherein the substrate is of an n type, and the contact layer is formed of a material selected from the group consisting of Al, Ti, W, Ta, and V.

3. The selective electrochemical etching method of claim 1, wherein the substrate is of a p type, and the contact layer is formed of a material selected from the group consisting of Au, Ag, Pd, Pt, and Ni.

4. The selective electrochemical etching method of claim 2, wherein:
the contact layer is formed of aluminum; and
an Ag wire is connected to the contact layer to electrically bias the contact layer.

5. The selective electrochemical etching method of claim 1, wherein the bias voltage is in the range of 0.01 to 100 V.

6. The selective electrochemical etching method of claim 2, wherein the bias voltage is in the range of 0.01 to 100 V.

7. The selective electrochemical etching method of claim 3, wherein the bias voltage is in the range of 0.01 to 100 V.

8. The selective electrochemical etching method of claim 4, wherein the bias voltage is in the range of 0.01 to 100 V.

9. The selective electrochemical etching method of claim 1, wherein a thickness of the contact layer is in the range between 1 nm and 100 μm.

10. The selective electrochemical etching method of claim 2, wherein a thickness of the contact layer is in the range between 1 nm and 100 μm.

11. The selective electrochemical etching method of claim 3, wherein a thickness of the contact layer is in the range between 1 nm and 100 μm.

12. The selective electrochemical etching method of claim 1, wherein the facing electrode and a wire connected to the facing electrode are formed of a material selected from the group consisting of Au, Pt, Os, Pd, Ir, Rh, Ru, Co, Ni, Mo, Ti, Fe, W, Ta, V, Be, and Cu.

13. The selective electrochemical etching method of claim 2, wherein the facing electrode and a wire connected to the facing electrode are formed of a material selected from the group consisting of Au, Pt, Os, Pd, Ir, Rh, Ru, Co, Ni, Mo, Ti, Fe, W, Ta, V, Be, and Cu.

14. The selective electrochemical etching method of claim 3, wherein the facing electrode and a wire connected to the facing electrode are formed of a material selected from the group consisting of Au, Pt, Os, Pd, Ir, Rh, Ru, Co, Ni, Mo, Ti, Fe, W, Ta, V, Be, and Cu.

15. The selective electrochemical etching method of claim 4, wherein the facing electrode and a wire connected to the facing electrode are formed of a material selected from the group consisting of Au, Pt, Os, Pd, Ir, Rh, Ru, Co, Ni, Mo, Ti, Fe, W, Ta, V, Be, and Cu.

16. The selective electrochemical etching method of claim 1, wherein the etchant includes a hydrofluoric acid (HF).

17. The selective electrochemical etching method of claim 2, wherein the etchant includes a hydrofluoric acid (HF).

18. The selective electrochemical etching method of claim 3, wherein the etchant includes a hydrofluoric acid (HF).

19. The selective electrochemical etching method of claim 4, wherein the etchant includes a hydrofluoric acid (HF).
